(19) United States
(12) Patent Application Publication
(10) Pub. No.: US 2007/0219986 A1
(43) Pub. Date: Sep. 20, 2007

(54) METHOD AND APPARATUS FOR EXTRACTING TERMS BASED ON A DISPLAYED TEXT

(75) Inventor: Ofer EGOZI, Moshav Bet Herut (IL)

Correspondence Address: SOROKER-AGMON ADVOCATE AND PATENT ATTORNEYS, NOLTON HOUSE, 14 SHENKAR STREET, HERZELIYA PITUACH, 46725, omitted

(73) Assignee: BABYLON LTD., Or Yehuda (IL)

(21) Appl. No.: 11/687,675

(22) Filed: Mar. 19, 2007

Related U.S. Application Data
(60) Provisional application No. 60/783,385, filed on Mar. 20, 2006.

(51) Int. Cl. G06F 17/30

(52) U.S. Cl. 707/5

(57) ABSTRACT

A method and apparatus for extracting terms associated with a displayed text. The method and apparatus receive a location indication from a user, read the text, determine the seed location within the text relating to the indicated location, determine the text surrounding the seed location in a determined scope, match terms from the determined text scope with a concept collection, choose the most dominant concepts which were matched, and extract terms that are associated with the dominant concepts.

### REFERENCES TO RELATED APPLICATIONS

This application claims priority from U.S. Provisional patent application No. 60/783,385, filed on Mar. 3, 2006 by the current inventor.

This application relates to U.S. Pat. No. 6,298,158, filed Sep. 25, 1997, titled “Recognition and Translation System and Method” assigned to the assignee of the present patent application, incorporated herein by reference.

### BACKGROUND OF THE INVENTION

1. Field of the Invention

The present invention relates to a method for extracting information from text, and more particularly to a method for formulating a query from text.

2. Background of the Invention

Keyword-based information retrieval servers, which return information units, e.g. documents, as a result of a textual query are common these days, the best known example being search engines on the Web. In order to use such engines, a user must first translate an information need to some keyword representation and then feed the keyword or keywords to the system to retrieve results. The query formulation stage requires logic and abstraction skills, as well as a level of understanding in the relevant subject. Therefore queries addressed to such systems tend to be short, often as one or two keywords only, as demonstrated for example, in Table 1 in “An Analysis of Web Searching by European AlltheWeb.com Users,” by Jansen and Spink, Information Processing and Management 41 (2005) pp. 361-381. The result of a short query is often a large number of returned documents, which calls for additional searches, thus reducing efficiency.

US Pat. Application 20050154746, by Hongche et al. assigned to Yahoo!, Inc. of Sunnyvale, Calif. discloses a system for determining associations between base content and relevant content and for publishing the base content and relevant content on a client browser. The system includes a parsing module configured to parse the base content; a unit-dictionary module including a plurality of query units; a unit-extraction module configured to extract query units from the unit dictionary according to the parsed base content; a unit-ranking module for ranking extracted query units based on relevancy; and a unit-matching module for generating associations between the base content and the relevant content.

U.S. Pat. No. 6,519,631 issued on Feb. 11, 2003 to Rosenschein et at. discloses a web-based information retrieval method including indicating word in a body of text displayed on a first computer, automatically transmitting via a network to a second computer, and receiving data relating to the word from the second computer.

U.S. Pat. No. 6,778,979, issued on Aug. 17, 2004 to Grefenstette et al. describes a method for automatically generating a query from a document, by considering the entire document. The method uses documents pre-categorized in category ontology, so that the search is limited to documents categorized to the same category as the document text. This approach is impractical in large-scale document collections, such as web search engines. Additionally, this method requires the user to indicate a section in the document text, which requires the user to determine the relevant part of the document.

In “Placing Search in Context: the Concept Revisited” by Finkelstein et al. presented in WWW10, May 1-5, 2001, Hong Kong., pp. 406-414, a system is disclosed based on the client-server paradigm, wherein a client application running on a user s computer captures the context around the text highlighted by the user for eliminating semantic ambiguity and vagueness in a search, and outputs the highlighted text and possibly additional terms from the surrounding text.

WO/2001/031479 invented by Ruppin et al. and assigned to Zapper discloses a system and method for retrieving and displaying search results. The method includes receiving text for a query and retrieving context surrounding the text; generating an augmented query, i.e., a query containing the received text and additional terms, to a search engine using the text and the context; and retrieving the output of the search engine. The system and method further use a domain selector for selecting a domain from a domain list, and a search engine selector for selecting the search engine from a list of search engines associated with the selected domain. The invention further includes a re-ranker for receiving search result summaries, and ranking them according to similarity to the text and the context. A server side of the invention implements algorithms for analyzing the context, selecting the most important context words, performing word-sense disambiguation, and preparing a set of augmented queries for subsequent search.

In “Y!Q: Contextual Search at the Point of Inspiration” by Kraft et al. presented in International Conference on Information and Knowledge Management (CIKM) 2005, pp. 816-823 a large-scale contextual search system is disclosed, which combines capturing high quality search context, and using that context to improve the relevancy of search queries. The authors claim that their system provides more flexibility over the Finkelstein et al., by allowing users to present any query and not just pre-defined text.

There is therefore a need in the art for a method and apparatus that would form a query from a point in text, by considering the subjects of the text around the point, but without requiring the user to indicate a specific word in the text or the relevant portion of the text. The method and apparatus should eliminate the need for a-priori knowledge about the characteristics or format of the target system to which the query is supplied. The method and apparatus should also be adaptable for commercial use such as determining advertisements to be presented to a user, or for determining relevant data from organizational information collection.

### SUMMARY

The present invention provides a novel method and apparatus for determining terms from displayed text. The terms are determined by considering an indicated location on the displayed text.

In an exemplary embodiment of the present invention, there is thus provided a method for determining an output term associated with a text displayed on a display device associated with a computing platform, the method comprising the steps of: receiving an indication to a location on the display device; identifying a seed location within the text displayed on the display device from the location indication; determining a scope of the text which includes the seed location; identifying one or more matches between a term from the scope of the text and a concept from a concept collection; identifying a dominant concept for which a match between the concept and an at least one term was identified; and extracting the output term as a term associated with the dominant concept. The method can further comprise a step of obtaining the text displayed on the display device. Optionally, the method comprises a step of selecting the concept collection from a multiplicity of concept collections. The concept collection is optionally a concept hierarchy. The method can further comprise a step of determining a language of the text, or a step of creating a query from the at least one output term. Optionally, the method comprises a step of stemming a word from the text. The method can further comprise a step of using the output term. The output term is optionally used as a query for a search engine. The dominant concept can be identified using clustering. The output term optionally comprises a weight indication. The weight indication can be associated with a distance between the output term and the seed location. The output term is optionally the term matched with the dominant concept. The scope of the text is optionally the text displayed on the display device. The scope of the text can be determined using topic segmentation or using grammatical segmentation. The method is optionally used for determining an advertisement to be presented to a user, or for retrieving information from enterprise data.

Another aspect of the disclosed invention relates to an apparatus for determining an output term from a text displayed on a display device, the display device associated with a computing platform, the apparatus comprising: an input device for receiving an indication for a location on the display device; a seed location identification component for identifying a seed location within the text displayed on the display device from the location indication; a text scope determination component for determining a part of the text displayed on the display device, the part includes the seed location; a term-concept matching component for matching a term from the scope of the text with a concept from a concept collection; a dominant concept identification component for identifying a dominant concept for which a match between the concept and a term was identified; and a term extraction component for extracting an output term associated with the dominant concept. The apparatus can further comprise a language determination component for determining the language in which the text is written. The apparatus optionally comprises a concept collection selection component for selecting the concept collection relevant to the text. Optionally, the apparatus comprises a text obtaining component for obtaining the text displayed on the display device.

Yet another aspect of the disclosed invention relates to a computer readable storage medium containing a set of instructions for a general purpose computer, the set of instructions comprising: receiving an indication to a location on the display device associated with a computing platform, the display device displaying text; identifying a seed location within the text displayed in the display device from the location indication; determining a scope of the text which includes the seed location; identifying a match between a term from the scope of the text and a concept from a concept collection; identifying a dominant concept for which a match between the concept and a term was identified; and extracting an output term as the term associated with the dominant concept.

### BRIEF DESCRIPTION OF THE DRAWINGS

The present invention will be understood and appreciated more fully from the following detailed description taken in conjunction with the drawings in which:

FIG. 1 is an illustration of a computer display exemplifying the usage and results of the disclosed method;

FIG. 2 is a flowchart of the steps in an exemplary implementation of the method for formulating query from a text; and

FIG. 3 is a block diagram of an exemplary apparatus for formulating a query from a text.

### DETAILED DESCRIPTION

A method and apparatus for determining output terms from a text document displayed on a display device for purposes such as formulating queries. The method and apparatus consider a location on the display device indicated by a user. The formulated query relates to the main topic or topics of the part of the text surrounding the indicated location rather than the indicated location itself The disclosed method and apparatus involve reading the document, identifying within the text the location indicated by the user, determining the relevant scope of the text surrounding the location, matching words contained in the scope against a concept collection, selecting the dominant concepts, and selecting from the text those words which relate to the most dominant concept or concepts.

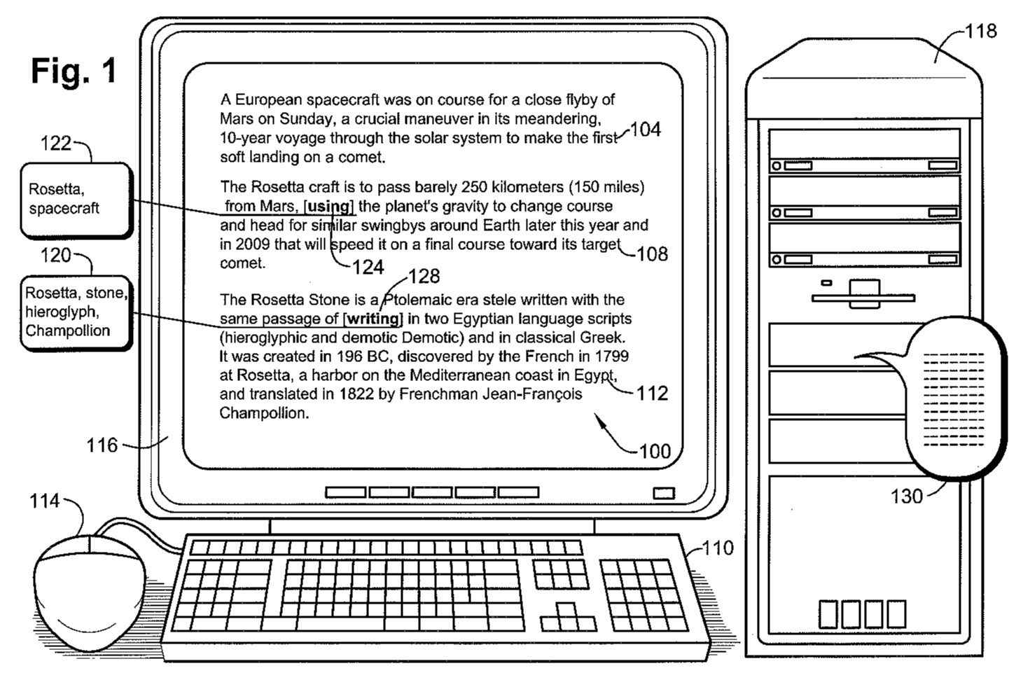

Referring now to FIG. 1, showing an exemplary usage of the disclosed method. Shown in FIG. 1 is a text displayed on a display device 116 connected to or otherwise associated with a computing platform 118, such as a personal computer, a mainframe computer, a network computer, a Personal Digital Assistant (PDA) or any other handheld device, a cellular phone or any other type of computing platform provisioned with a memory device (not shown), a CPU or microprocessor device, and input devices such as a keyboard 110, a pointing device such as a mouse 114, a joystick or the like. Display 116 is any display, such as CRT, LCD, a display associated with the device such as a PDA, or the like. The disclosed apparatus preferably comprises an application 130 executed by the computing platform, and implemented as one or more components comprising computer instructions written in any programming language, such as C, C++, C#, Java, or the like, and under any development environment. Alternatively, the apparatus can be implemented as firmware ported for a specific processor such as digital signal processor (DSP) or microcontrollers, or as hardware or configurable hardware such as field programmable gate array (FPGA) or application specific integrated circuit (ASIC). Application 130 can be integrated into one or more applications, such as an operating system, a word processor, or the like.

The text displayed on display 116, generally referenced 100, comprises three paragraphs, 104, 108 and 112. A closer look at the text will show that paragraphs 104 and 108 deal with the Rosetta craft soon to fly near Mars, while paragraph 112 discusses the Rosetta stone. Thus, it would be desirable that when a user indicates a position within paragraphs 104 or 108, the suggested query will include the terms “Rosetta” and “Spacecraft” as indicated in window 116, while clicking anywhere within paragraph 112 will yield a query related to “Rosetta”, “stone”, “Hieroglyph”, or “Champollion”, as indicated in window 120.

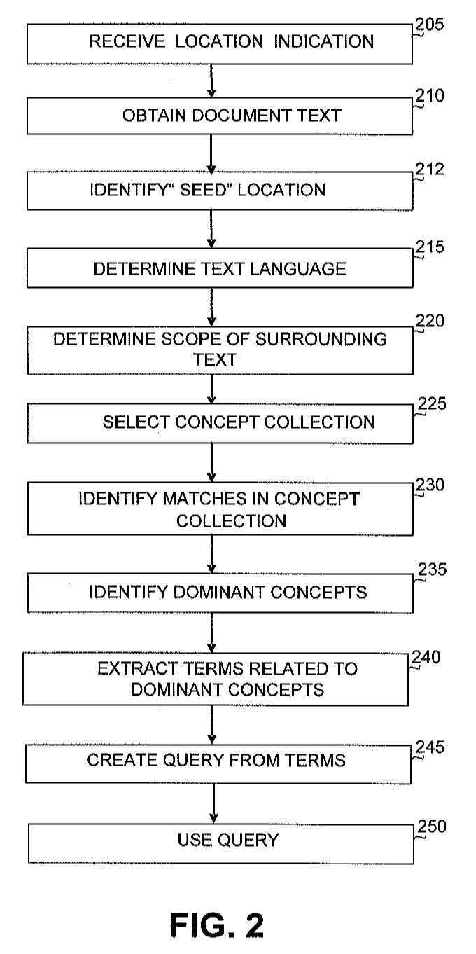

Referring now to FIG. 2, showing a flowchart of the main steps in the disclosed method. The method starts when text is displayed on a display device as detailed in association with FIG. 1. The displayed text preferably comprises words, spaces, or punctuation marks. On step 205 the system receives an indication to a location on the display from a user viewing the text, such as location 124 on FIG. 1. The indication is provided by a mouse, a keyboard, a joystick or any other device which can indicate a location on a screen. The location is preferably indicated in a set of screen coordinates. On step 210 at least a part of the document, preferably the whole document, is obtained, i.e. read into memory or auxiliary persistent storage. Obtaining the document can be by accessing an external tool, or an application program interface of the displaying application. On step 212 a seed location, i.e. the location within the document, such as the word, space between words, space between paragraphs or the like, is identified from the document and from the location pointed to by the user. Reading the text can be performed by accessing a component that displays the text, by using any on-screen recognition methods, such as the method described in U.S. Pat. No. 6,298,158 issued to the current inventor, or any other method. On step 215 the language of the text is determined. Step 215 is only required in multi-lingual environments. The language is possibly identified by considering additional words around the seed location. Identifying the language can be performed in any known method, such as the method described in U.S. Pat. No. 6,023,670 incorporated herein by reference. In FIG. 1 the language will be identified as English. On step 220, the relevant scope surrounding the seed location recognized on step 210 is determined. If the seed location is at or near the end or the beginning of the text, then the scope of text will contain only the seed location and further text before or after the seed location, respectively. In a preferred implementation, the scope consists of the part of the document which is relevant to the same topic as the text immediately surrounding the seed location. Step 220 is especially required when the displayed document relates to more than one subject. However, the topic resolution depends on the subject matter of the text. For example, when referring to astronomy, Mars and Jupiter can be considered as two different subjects, but when discussing various fields of science, both Mars and Jupiter will refer to “Astronomy”. In a preferred alternative, the scope can be determined as the whole document, or as the part of the document displayed on the display device. In yet another preferred embodiment, the determination of the scope of the text can be performed by a third party tool or product. The resolution can be determined by using thresholds or other parameters as in step 235 detailed below. In another alternative, the scope can be identified as a grammatical segment, such as one or more paragraphs, sections or the like. In yet another alternative the scope can be determined by a number of words preceding the seed location and a number of words following the seed location, a radius on the display device wherein the words within the radius are included in the scope, or the like. Thus, the scope can be a paragraph, a topic segment, an entire page, the entire document or any other part thereof and can be determined by identifying a grammatical paragraph, by using topic-based methods such as “topic segmentation” as detailed in “Topic Segmentation: Algorithms and Applications (1998)” by Jeffrey C. Reynar (http://citeseer.ist.psu.edu/reynar98topic.html), or the like. In FIG. 1, if the user pointed at the word “using” 124, if topic segmentation is used, the scope will comprise paragraphs 104 and 108, while if document structure segmentation is used, then the scope will comprise only paragraph 108. If the user pointed at the word “writing” 128 the scope will be paragraph 112. Pointing at a location can be performed not only by a human user but also by a third party application, automatic process, equipment or any other entity. Once the scope is determined, a relevant concept structure or concept collection is selected on step 225. In the current context a concept is an abstract idea or symbol, typically associated with an entity, interactions, phenomena, or relationships there between. A concept collection is a multiplicity of concepts, wherein each concept is associated with one or more terms. The relationship between concepts and terms is preferably many-to-many, i.e., each term may relate to multiple concepts, and each concept is associated with multiple terms. Matching a term in a concept collection preferably comprises searching for a term within the concept collection related to the searched term, and indicating the concept or concepts associated with the term. The meaning of “related” includes identity between the searched term and a concept, but also similarity, such as resulting from stemming a word, finding a phrase, or the like. The concept collection selection is relevant only if a multiplicity of concept collections is available. For example, if legal, medical, political, or general concept collections are available, the most relevant one is determined, preferably based on the selected scope of the document. In a preferred implementation, the selected concept structure is the one which contains the most terms or words from the scope. The concept collection may be implemented as a concept list, a concept hierarchy, or any other data structure. For example, such a general concept hierarchy can be built using the articles of a computerized encyclopedia such as Wikipedia (www.wikipedia.org), by taking all article titles as terms, and the categories each article is assigned to as concepts associated with the term. The relations between the terms and the concepts, together with the relations between the categories form the hierarchy. Similarly, a concept-hierarchy can be built out of Web Directories, a Corporate Taxonomy, Advertising keywords database and similar resources. A concept hierarchy is concept collection in which excluding the root concept, each concept is a descendent of one or more other concepts, i.e. each concept has an “is-a” connection to an at least one other concept. For example, the concept of “Jupiter” may be a descendent of the concept “Astronomy”, which in turn is a descendent of the concept “Science”. In the example of FIG. 1, the relevant concept collection will be “astronomy” or “scientific” collection, if one is available, or a general collection otherwise. Once the concept collection is selected on step 225, matches for terms in the determined text scope are searched for within the concept structure on step 230. In the current context, the word “term” relates to one or more consecutive words appearing in the text. Step 230 is functional in searching matches, i.e. concepts related to terms which correspond to the longest possible phrases in the text. For example, in a text containing the phrase “as soon as”, the term “as soon as” will be preferred over “as” or “soon”. Similarly, in a sentence containing the phrase “along the coast of the Mediterranean sea”, the term “Mediterranean sea” will be preferred over “Mediterranean” or “sea” separately. Matching the longest possible phrase is preferably done in the following method: suppose the document scope consists of words enumerated I to j. Then, the first tried match is the whole sequence, word I to word j. If no match is found, then a match is searched for words i . . . (j−1). If still no match is found, then a search is done for i . . . (j−2) and so on. Then, searches are performed starting at the i+1 word, for the sequences of (i+1) . . . j, (i+1) . . . (j−1) and so on. A word that participates in a term for which a match was found will preferably not be searched again, neither as a single word, nor as part of another term. In the example of FIG. 1, step 230 will include matching all words and word sequences of paragraphs 104 and 108 with the selected collection. On step 235, the dominant concepts are identified out of the multiplicity of concepts obtained on step 230. The dominant concepts are identified using methods such as taking the most frequent concepts among the concepts pointed at by the terms of the text, or clustering, for example hierarchical clustering, K-means clustering, or the like. For some methods, such as clustering, a distance measure between concepts should be defined. Thus, for clustering purposes, only concept collections which provide a distance measure, such as a concept hierarchy, can be used. The resolution between concepts as discussed in association with step 220 above can be determined by taking into account the distance between concepts and common ancestors. For example, if the terms “Jupiter” and “biology” are detected, the concept “Science” can be suggested, if it is a common ancestor, but if “Mars” and “Jupiter” are detected, then “astronomy” can be suggested. When the concept collection is the concept hierarchy, the distance is preferably defined as the length of the shortest path between two concepts. The dominant concepts can also include additional information. For example, if the concept collection is a concept hierarchy, then if two or more terms belong to the same sub-tree, the common ancestor of the sub-tree can be added to the concepts, as well as additional terms relating to dominant concepts, a word or words associated with a topic detected for the scope of the text, or other words or word combinations. In the current example, the dominant concepts can be “Rosetta craft”, “Mars”, “Solar system” or the like. When identifying a dominant concept, weight can be assigned to a concept associated with a specific term, according to the number of times the concept was referred to from words within the considered text, the referring terms' relative distances, counted for example by words from the seed location, or another factor. In another preferred embodiment, all detected concepts can be considered dominant concepts and taken into account. On step 240 the terms from the selected scope which relate to the most dominant concept or concepts are obtained as the output terms. In the example of FIG. 1 the terms that relate to the dominant concepts may include the words “Mars”, “Rosetta craft”, “gravity”, “Earth”, “Comet” and possibly additional ones. On optional step 245 the terms selected on step 240 are collected into a query. In a preferred alternative, terms can be incorporated into a query according to their relative distance from the seed term. Thus, a word's probability to be incorporated into a query is higher if the word is closer to the seed word. Alternatively, if the query is required for purposes such as a search performed by a search engine capable of receiving weights for the terms in an input query, then the weight associated with a term, which may be related to its proximity to the seed term, may be integrated into the query. In an alternative embodiment, concepts such as common ancestors or dominant concepts mentioned above can be added to the query as well. On optional step 250 the query is used according to the user's needs, such as sending the query to a search engine, generating a summary of the text, or the like. Additional steps may include stemming the words, i.e. conjugating nouns to a singular form and words to present form prior to identifying matches in concept hierarchy on step 230, or prior to creating a query on step 245, removing stop words, such as the words “in”, “the” prior to determining the scope of surrounding text in step 220, or the like.

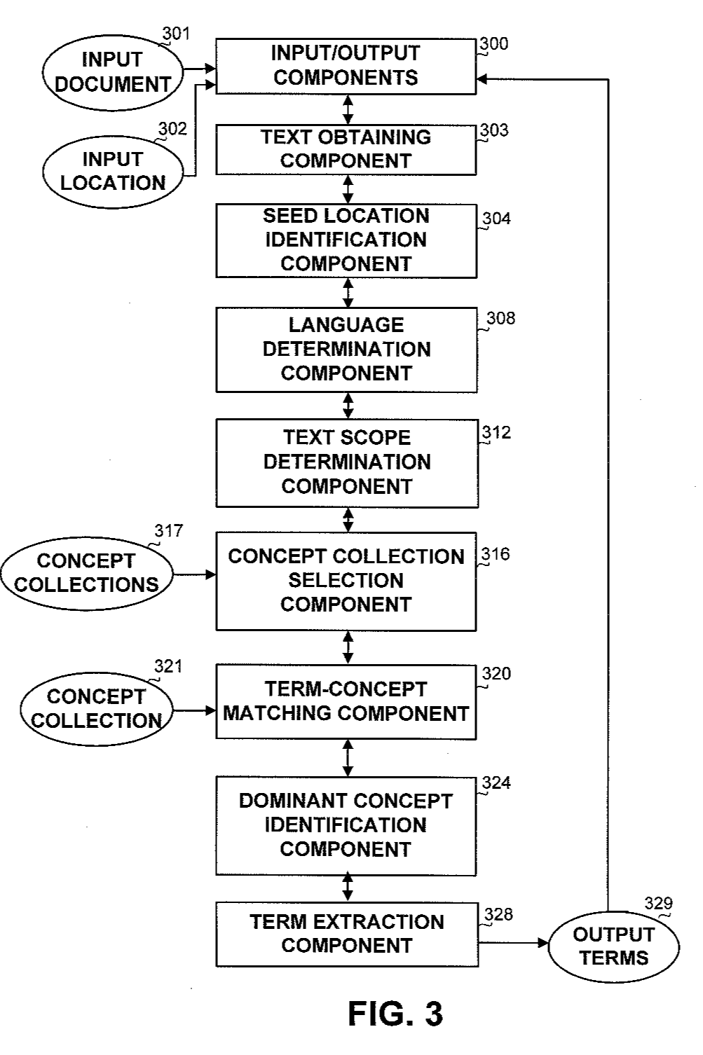

Referring now to FIG. 3, showing a block diagram of a preferred embodiment of the disclosed apparatus. The apparatus comprises input and output components 300, and additional components that are functional in carrying out the disclosed method. Input/output components 300 include input devices such as a keyboard 110, a mouse 114 both of FIG. 1, a joystick, or another device that enables a user to refer to a displayed text and indicate a location within the text and a display 116 of FIG. 1 for displaying the original text, and possibly the resulting query formulated by the apparatus. Exemplary input and output physical devices are shown in FIG. 1, as keyboard 110, mouse 114 and display 116. Input/output component 300 display input document 301 and receive input location 302. The physical devices generally require appropriate software in order to communicate with the computing platform 118 of FIG. 1. The other components shown in FIG. 3 are preferably software components that perform the tasks associated with the disclosed method. It will be appreciated by a person skilled in the art that the disclosed components and the division of the tasks to components are exemplary only, and other components and divisions can be used without departing from the spirit of the disclosed method and apparatus. The software components can be written in any programming language and under any development environment such as NET, J2EE. The various components can be executed on one computing platform or on multiple connected platforms.

The components include text obtaining component 303 for reading the text into memory or persistent storage, or receiving the text from another source, and seed location identification component 304, for determining the location within the text to which the user referred, as detailed in association with step 212 of FIG. 2 above. Seed location component 304 receives as input the screen coordinates indicated by the user and provides the seed location within the text.

Language determination component 308 is used for determining the language of the relevant text, and is used when the text is possibly a multi-lingual text, or when the text language is unknown. If the language is known, then component 308 is optional. Text scope determination component 312 is used for determining the scope of the text around the seed term which should be considered for constructing a query The scope can be limited by a structural limitation such as a paragraph or by topic, as detailed in association with step 220 of FIG. 2 above. Yet another component is concept-collection selection component 316, for selecting the most relevant concept structure or concept collection available for the topic, or a general concept collection if no need for a specific collection is identified from concept collections 317, as detailed in association with step 225 of FIG. 2 above. The apparatus further comprises term-concept matching component 320 for matching the terms appearing in the scope of the text selected by text scope determination component 312, using concept collection 321 selected by concept collection selection component 316 from concept collections 317. Yet another component is dominant concept identification component 324 for identifying the most dominant concepts among the concepts matched by term-concept matching component 320. Term extraction component 328 is functional in extracting those terms of the scope of the text, which relate to one or more of the dominant concepts identified by dominant concept identification component 324. The extracted terms, or some of them, form the output terms which are optionally transferred to input/output components 300.

The disclosed method and apparatus enable the formulation of a query according to a topic of the text surrounding a pointed location. The method and apparatus do not require access to the target document collection, and can therefore be implemented on a stand-alone computing platform. It will be appreciated by a person skilled in the art that the disclosed method and apparatus can be used for general purposes, as well as more specific purposes. For example, the method and apparatus can be used for determining advertisements to be chosen for presenting or for sending to a user viewing the text, or for retrieving data from within one or more collections of organizational data.

It will be appreciated by a person skilled in the art that other component structures can be designed which perform the disclosed method. Components can be added, deleted or changed, or components can communicate in a different manner than described, and modifications such as additional, less, or different steps for carrying out the disclosed method can be implemented, one or more of the steps can be performed by third party or external tools, which can also replace components of the disclosed apparatus, without departing from the spirit of the current invention.

It will be appreciated by persons skilled in the art that the disclosed method and apparatus are not limited to what has been particularly shown and described hereinabove. Rather the scope is defined only by the claims which follow.

What is claimed is:

1. A method for determining an at least one output term associated with a text displayed on a display device associated with a computing platform, the method comprising the steps of:
receiving an indication to a location on the display device;
identifying a seed location within the text displayed on the display device from the location indication;
determining a scope of the text which includes the seed location;
identifying an at least one match between at least one term from the scope of the text and an at least one concept from a concept collection;
identifying an at least one dominant concept for which an at least one match between the at least one concept and the at least one term was identified; and
extracting the at least one output term as an at least one term associated with the at least one dominant concept.

2. The method of claim 1 further comprising a step of obtaining the text displayed on the display device.

3. The method of claim 1 further comprising a step of selecting the concept collection from a multiplicity of concept collections.

4. The method of claim 1 further comprising a step of determining a language of the text.

5. The method of claim 1 further comprising a step of creating a query from the at least one output term.

6. The method of claim 1 further comprising a step of stemming an at least one word from the text.

7. The method of claim 1 farther comprising a step of using the at least one output term.

8. The method of claim 7 wherein the at least one output term is used as a query for a search engine.

9. The method of claim 1 wherein the concept collection is a concept hierarchy.

10. The method of claim 1 wherein the at least one dominant concept is identified using clustering.

11. The method of claim 1 wherein each of the at least one output term comprises a weight indication.

12. The method of claim 11 wherein the weight indication is associated with a distance between the at least one output term and the seed location.

13. The method of claim 1 wherein the at least one output term is the at least one term matched with the at least one dominant concept.

14. The method of claim 1 wherein the scope of the text is the text displayed on the display device.

15. The method of claim 1 wherein the scope of the text is determined using topic segmentation.

16. The method of claim 1 wherein the scope of the text is determined using grammatical segmentation.

17. The method of claim 1 when used for determining an at least one advertisement to be presented to a user.

18. The method of claim 1 when used for retrieving information from enterprise data.

19. An apparatus for determining an at least one output term from a text displayed on a display device, the display device associated with a computing platform, the apparatus comprising:
an input device for receiving an indication for a location on the display device;
a seed location identification component for identifying a seed location within the text displayed on the display device from the location indication;
a text scope determination component for determining an at least one part of the text displayed on the display device, the part includes the seed location;
a term-concept matching component for matching an at least one term from the scope of the text with an at least one concept from a concept collection;
a dominant concept identification component for identifying an at least one dominant concept for which an at least one match between the at least one concept and the at least one term was identified; and
a term extraction component for extracting an at least one output term associated with the at least one dominant concept.

20. The apparatus of claim 19 further comprising a language determination component for determining the language in which the text is written.

21. The apparatus of claim 19 further comprising a concept collection selection component for selecting the concept collection relevant to the text.

22. The apparatus of claim 19 further comprising a text obtaining component for obtaining the text displayed on the display device.

23. A computer readable storage medium containing a set of instructions for a general purpose computer, the set of instructions comprising:
receiving an indication to a location on the display device associated with a computing platform, the display device displaying text;
identifying a seed location within the text displayed in the display device from the location indication;
determining a scope of the text which includes the seed location;
identifying an at least one match between at least one term from the scope of the text and an at least one concept from a concept collection;
identifying an at least one dominant concept for which an at least one match between the at least one concept and the at least one term was identified; and
extracting an at least one output term as the at least one term associated with the at least one dominant concept.
